(19) United States
(12) Patent Application Publication
(10) Pub. No.: US 2004/0233480 A1
(43) Pub. Date: Nov. 25, 2004

(54) Image capture device with retractable lid

(76) Inventor: Justin A. Tehrani, Broomfield, CO (US)

Correspondence Address: HEWLETT-PACKARD COMPANY, Intellectual Property Administration, P.O. Box 272400, Fort Collins, CO, 80527-2400, US

(21) Appl. No.: 10/444,381

(22) Filed: May 23, 2003

(51) Int. Cl. H04N 1/04

(52) U.S. Cl. 358/474

(57) ABSTRACT

In accordance with an embodiment of the present invention, an image capture device comprises a platen adapted to receive an object to be scanned and a retractable lid operable to cover the platen.

### FIELD OF THE INVENTION

The present invention relates generally to the field of image capture devices, and more particularly to an image capture device with a retractable lid.

### BACKGROUND OF THE INVENTION

The use of scanners has substantially increased over the years. Scanners are increasingly being used to capture images of different kinds of objects, such as documents, photographs, negatives, transparencies, and/or the like. A scanner typically comprises a pivotable lid that is coupled to a housing of the scanner. The lid is operable to cover a platen of the scanner and keep the object to be scanned in a predefined area on the platen. The lid also keeps the platen dust free and ready for use. However, the lid adds to the bulk of the scanner. Also, because of the manner in which the lid is coupled to the housing, a clearance area above the scanner is required to raise and lower the lid.

### SUMMARY OF THE INVENTION

In accordance with an embodiment of the present invention, an image capture device comprises a platen adapted to receive an object to be scanned and a retractable lid operable cover the platen.

In accordance with another embodiment of the present invention, an image capture device comprises a housing and a lid operable to cover a platen when said lid is extended, said lid operable to retract into said housing.

### DESCRIPTION OF THE DRAWINGS

For a more complete understanding of the present invention, the objects and advantages thereof, reference is now made to the following descriptions taken in connection with the accompanying drawings in which:

FIGS. 1A and 1B are perspective views of a prior art scanner;

FIG. 2A is a perspective view of an image capture device with a lid in a retracted position in accordance with an embodiment of the present invention;

FIG. 2B is a sectional view taken along section 2B-2B of the image capture device of FIG. 2A;

FIG. 2C is a perspective view of the image capture device of FIG. 2A with the lid in an extended position;

FIG. 3 is a plan view showing the top of the image capture device of FIG. 2A; and

FIG. 4 is a perspective view of an image capture device with a lid in a retracted position in accordance with another embodiment of the present invention.

### DETAILED DESCRIPTION OF THE DRAWINGS

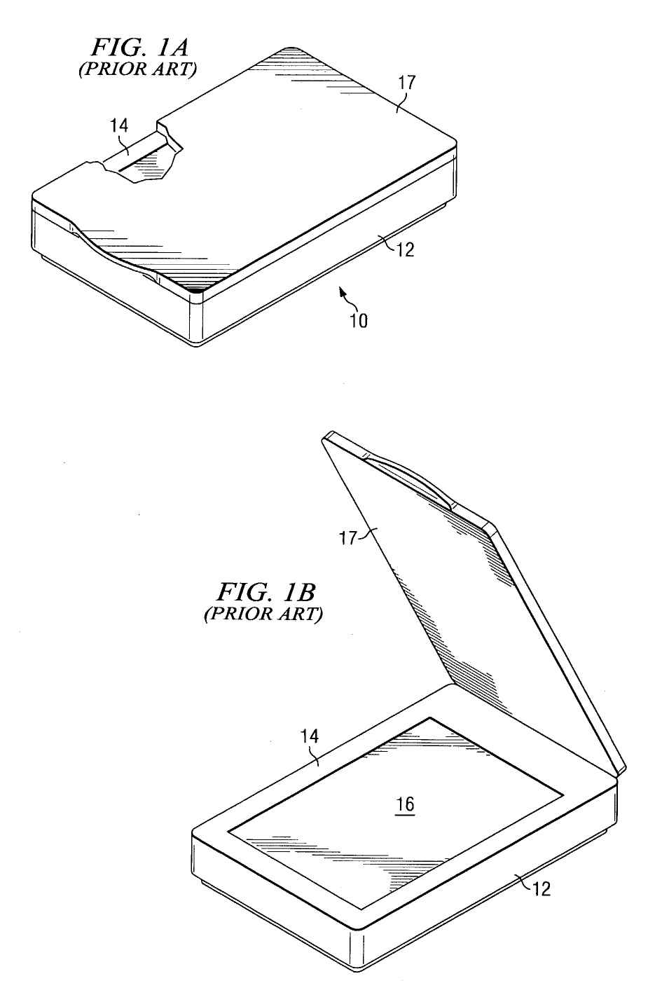

The preferred embodiment of the present invention and its advantages are best understood by referring to FIGS. 1 through 4 of the drawings, like numerals being used for like and corresponding parts of the various drawings.

The present invention will be described herein with reference to an image capture device, such as a scanner. The teachings of the present invention may be used with respect to other types of image capture devices, such as photocopiers, digital senders, and/or the like. If desired, the image capture device may be part of a copier, a multi-function device, a facsimile machine, or other machine that makes a digital image for storage, transmission and further processing. The terms “image capture device”, “flatbed scanner” and “scanner” are used interchangeably herein.

FIGS. 1A and 1B are perspective views of a prior art scanner 10. Scanner 10 comprises a housing 12. Housing 12 comprises a scanner top 14. Scanner top 14 comprises a platen 16 (FIG. 1B) against which an object to be scanned, such as a document, a photograph, a negative, a transparency, and/or the like, may be placed. Scanner 10 also comprises a lid 17 pivotally coupled to scanner top 14.

In order to scan an object using scanner 10, a user raises lid 17 and places the object on platen 16. After placing the object on platen 16, the user lowers lid 17. Lid 17 holds the object in position on platen 16 during scanning. Since lid 17 is pivotally coupled to scanner top 14, a clearance area above scanner 10 is needed to allow lid 17 to be raised for placing the object on platen 16. Also, as illustrated in FIG. 1A, the inclusion of lid 17 with scanner 10 increases the bulk or vertical dimension of scanner 10.

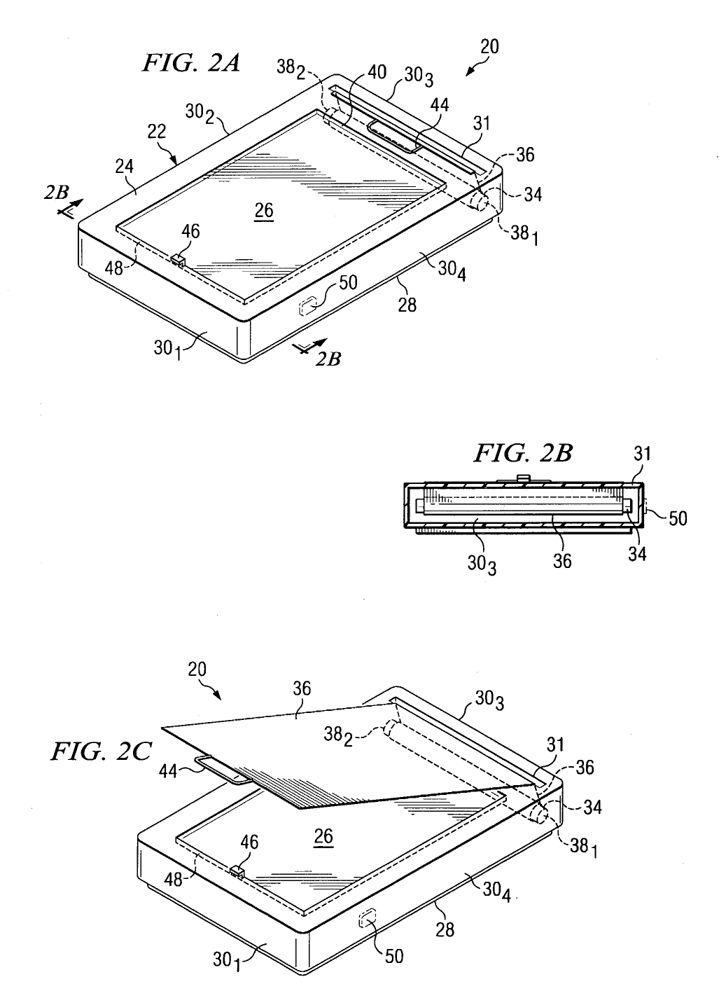

Referring to FIGS. 2A, 2B and 2C, scanner 20 comprises a housing 22. Housing 22 comprises a scanner top 24 and a scanner base 28 opposite scanner top 24. Housing 22 also comprises a plurality of vertical sides 301, 302, 303 and 304. Scanner top 24 comprises s a platen 26 against which an object to be scanned may be placed. Platen 26 comprises a first end 40 and a second end 48 opposite first end 40. In accordance with an embodiment of the present invention, scanner 20 comprises a retractable lid 36, which in an extended position covers platen 26 as shown in FIG. 2C. Lid 36 is flexible and may comprise a polyester film, such as MYLAR.

In accordance with an embodiment of the present invention, scanner top 24 comprises an opening 31 which leads into an interior space in housing 22. Preferably, the length of opening 31 is greater than the width of platen 26. In the illustrated embodiment, opening 31 is located in proximity to first end 40 of platen 26 and is provided along a width of scanner 20 in proximity to first end 40 of platen 26. If desired, opening 31 may be provided along a length of scanner 20.

A retractable lid storage member 34 is provided inside housing 22. The inside of housing 22 may be used for storing lid 36 when it is in a retracted position. If desired, retractable lid storage member 34 may be provided on scanner top 24 (FIG. 4). In such an embodiment, lid 36 may be stored outside housing 22.

Referring to FIGS. 2A, 2B and 2C, lid storage member 34 is preferably a circular rod so that, in the retracted position, lid 36 may wrap around lid storage member 34. Lid storage member 34 comprises two ends 38, and 382 which are coupled to scanner housing 22. Preferably, ends 38, and 382 are coupled to housing 22 in a manner that allows lid storage member 34 to be freely rotatable. Lid storage member 34 is releasably coupled to housing 22 so that, if desired, it may be easily removed to replace lid 36 and/or lid storage member 34 itself.

Lid storage member 34 may include a biasing element (not explicitly shown), for example a spring, that causes lid 36 to wrap around lid storage member 34 when no other force is applied on lid 36. A first end of lid 36 is coupled to lid storage member 34 while a second end opposite the first end is freely movable. A coupling element 44, such as a fastener, a handle, a slide bar, a sticking pad, a hook-and-loop segment, a cord, a magnet, a latch, a hook and/or the like, may be attached to lid 36 at or near the second side. The user may use coupling element 44 to latch lid 36 with another coupling element 46 provided in proximity to second end 48 of platen 26. Coupling element 46 is preferably complementary to coupling element 44 and may be provided on scanner top 24. Coupling element 44 may also be used as a handle to pull lid 36 out from its retracted position.

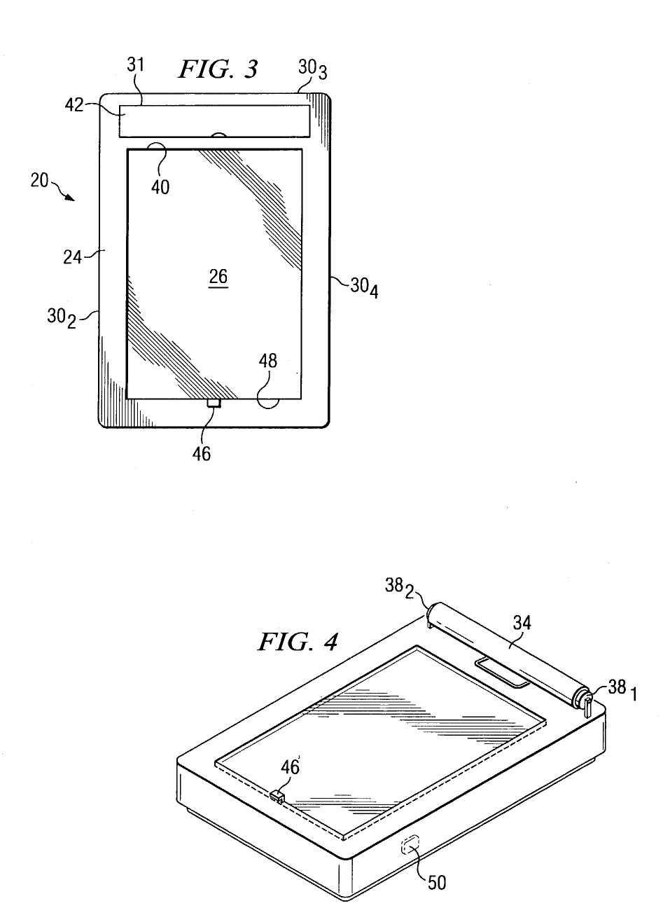

Referring to FIG. 3, a cover 42 is provided on housing 22 in a preferred embodiment so that opening 31 in scanner top 24 may be covered when lid 36 is in the retracted position inside housing 22. Cover 42 may be pivotally coupled to scanner top 24.

When a user desires to scan an object, the user places the object against platen 26. The user may then open cover 42 of opening 31 and pull out lid 36 from its retracted position. The user may then pull lid 36 across platen 26 and engage coupling element 44 with coupling element 46 disposed near second end 48 of platen 26. The latching of coupling element 44 with coupling element 46 prevents lid 36 from automatically retracting into housing 22 via opening 31 due to action of the biasing element associated with lid storage member 34. In this position of lid 36, platen 26 and the object placed thereon are covered by lid 36. Because of the biasing element, lid storage member 34 pulls on lid 36 to retract it. This causes lid 36 to be pulled tightly across platen 26. Thus, lid 36 is maintained substantially flat over platen 26, preventing undesirable light from entering scanner 20 during the scanning process. Once the object has been scanned, coupling element 44 may be disengaged from coupling element 46 to release lid 36. Upon being released, lid 36 automatically wraps around lid storage member 34 because of the spring mechanism associated with lid storage member 34. Lid 36 may then automatically retract into housing 22.

In an alternative embodiment, a conventional roller shade type mechanism (not explicitly shown) may be used to position lid 36 over platen 26. In such an embodiment, lid 36 is sufficiently stiff so that in the extended position it lays substantially flat on platen 26 preventing undesirable light from entering scanner 20. Once extended over platen 26, lid 36 stays in the extended position until the user pulls on lid 36 to unlock the lid. Lid 36 then retracts automatically and wraps around lid storage member 34. In this embodiment, coupling elements 44 and 46 are optionally not employed.

In another alternative embodiment, a conventional roller shade type mechanism (not explicitly shown) may be used to position lid 36 over platen 26. In such an embodiment, lid 36 is sufficiently stiff so that in the extended position it lays substantially flat on platen 26 preventing undesirable light from entering scanner 20. Once extended over platen 26, lid 36 stays in the extended position until the user activates a button 50 to release the lid. Lid 36 then retracts automatically and wraps around lid storage member 34. In this embodiment, coupling elements 44 and 46 are optionally not employed.

A technical advantage of an exemplary embodiment of the present invention is that a substantial clearance above the scanner is no longer needed to operate the scanner.

Although embodiments of the present invention have been discussed herein with reference to flatbed scanners, the invention is not so limited. The teachings of the illustrated embodiments may be used in various other applications. For example, newer industrial scanners have transparent top and bottom surfaces and do not include any lid. Such scanners may benefit from use of a retractable lid in accordance with the teachings of the present invention.

Furthermore, many scanners comprise a feeder, such as an automatic document feeder (ADF) or an automatic photo feeder (APF), which is part of the lid. The feeder includes belts to automatically feed objects from the feeder onto the platen for scanning. When these scanners are used to scan objects, the resultant image may include dark bands corresponding to the belts associated with the feeder mechanism. In order to avoid the appearance of such dark bands, the scanner may be provided with a retractable lid. When scanning an object manually, the user may use the retractable lid to maintain the object in its place and also to provide a uniform background for scanning. Some other scanners which comprise a media adapter integrated into the lid also suffer from the same problem of one or more dark bands appearing in scanned images. Such scanners may also be provided with a retractable lid in accordance with an embodiment of the present invention.

What is claimed is:

1. An image capture device, comprising:
a platen adapted to receive an object to be scanned; and
a retractable lid operable to cover said platen.

2. The image capture device of claim 1, further comprising a housing adapted to store said retractable lid.

3. The image capture device of claim 2, wherein said housing comprises an opening.

4. The image capture device of claim 1, further comprising:
a housing; and
a retractable lid storage member disposed in said housing,

5. The image capture device of claim 1, wherein one end of said retractable lid is coupled to a retractable lid storage member.

6. The image capture device of claim 1, further comprising:
a housing; and
a retractable lid storage member disposed on said housing.

7. The image capture device of claim 5, further comprising a biasing element associated with said retractable lid storage member to cause said lid to automatically retract into a housing.

8. The image capture device of claim 5, further comprising a biasing element associated with said retractable lid storage member to cause said lid to automatically wrap around said retractable lid storage member.

9. The image capture device of claim 1, further comprising a coupling element disposed on a second end of said retractable lid, said second end being distal from a first end of said retractable lid.

10. The image capture device of claim 9, further comprising a second coupling element, said second coupling element disposed on said housing to engage with said first coupling element when said lid is in an extended position.

11. The image capture device of claim 9, wherein said coupling element is selected from the group consisting of a fastener, a handle, a slide bar, a sticking pad, a hook-and-loop segment, a cord, a latch, a hook and a magnet.

12. An image capture device, comprising:
a housing; and
a lid operable to cover a platen when said lid is extended, said lid operable to retract into said housing.

13. The image capture device of claim 12, said housing adapted to store said lid.

14. The image capture device of claim 12, further comprising a rotatable retractable lid storage member coupled to at least a portion of said housing.

15. The image capture device of claim 12, wherein an end of said lid is coupled to a retractable lid storage member disposed inside said housing.

16. The image capture device of claim 12, further comprising a coupling element provided on a second end of said lid, said second end being distal from a first end of said lid.

17. The image capture device of claim 16, further comprising another coupling element provided on said housing to engage with said first coupling element when said lid is in an extended position.

18. The image capture device of claim 15, further comprising a biasing element associated with said retractable lid storage member, said biasing element operable to cause said lid to automatically retract into said housing.

19. The image capture device of claim 15, further comprising a biasing element associated with said retractable lid storage member, said biasing element operable to cause said lid to automatically wrap around said retractable lid storage member.

20. The image capture device of claim 12, further comprising a cover coupled to said housing and operable to cover an opening of said housing.

21. An image capture device, comprising:
means for receiving an object to be scanned; and
means for covering said means for receiving, said means for covering being retractable.

22. The image capture device of claim 21, further comprising means for storing said means for covering.
